(19) United States
(12) Patent Application Publication
(10) Pub. No.: US 2006/0203842 A1
(43) Pub. Date: Sep. 14, 2006

(54) Dongle-type network access module

(76) Inventors: Steven M. Wollmershauser, San Antonio, TX (US); David Benjamin Small, Dublin, CA (US); Yolius Diroo, San Antonio, TX (US)

Correspondence Address: TOLER SCHAFFER, LLP, 5000 PLAZA ON THE LAKES, SUITE 265, AUSTIN, TX, 78746, US

(21) Appl. No.: 10/989,214

(22) Filed: Nov. 12, 2004

(51) Int. Cl. H04L 12/66

(52) U.S. Cl. 370/463

(57) ABSTRACT

A network access module having a dongle-type housing is provided. The dongle-type housing is coupleable to a computer port and when coupled to a communications network, the dongle-type network access module provides an efficient plug-and-play network connection. The network access module can be powered by a USB-port on a subscriber's computer. The subscriber can connect to a communications network using the network access module over digital subscriber lines (DSL) that use optical fiber transmission lines and optical network terminals. The network access module contains a processor for performing point-to-point access negotiation with the authentication server such that the subscriber can access the communications network without having to provide/load software.

### BACKGROUND

1. Field of the Disclosure

The present disclosure relates generally to computer networks and the initiation of communications over computer networks and more particularly to a dongle-type plug and play network access module.

2. Description of the Related Art

The popularity of the Internet and the need to communicate continues to grow. In an effort to sell services and to reduce operating costs, Internet services providers (ISPs) have made a significant investment in providing systems that are easy to use. Connection and re-connection to the Internet has become easier and more user-friendly over the past few years, however problems remain.

It is a goal of the ISPs to provide customers with a pleasant, trouble-free experience. Many new subscribers are novice computer users and initial subscriber set up often causes customer relation problems. ISPs desire to connect and re-connect subscribers to the Internet with reduced customer effort and expense.

When an ISP engages a new subscriber they often provide the new subscriber with a means for connecting to the ISP's network. The classical method to establish a relationship between a subscriber/user and an ISP includes the ISP mailing a software package to the new subscriber. The new subscriber loads the software onto his/her computer and performs a setup procedure.

One of the problems that ISPs face is that different subscribers often have different types of computers. New subscribers also have computers with substantially different performance specifications. Computers vary widely in their capabilities, such as speed, memory capacity, and operating system. Thus, based on the type of computer of each subscriber, the ISP must create and supply the appropriate version of startup software and instructions to the new subscriber.

If a new subscriber is not “computer literate” then loading software can be burdensome and the new subscriber may become frustrated and cancel their subscription. Often, an ISP will provide customer telephone support to mitigate this problem, but such support is expensive. Telephone support often creates customer relation problems due to long hold times, language barriers, and availability.

To avoid the process of loading software onto a subscriber's computer, a subscriber may purchase a router. Generally, a router allows more than one computer to share a single network connection. The router can contain network startup software, which can eliminate the need for a subscriber to load software onto their computer. However, a router can cost tens or hundreds of dollars. Most new subscribers prefer not to incur this additional expense.

Thus, the current method utilized by ISPs to connect subscribers to a network has significant shortcomings. Accordingly, there is a need to improve the process of establishing and re-establishing network communications.

### BRIEF DESCRIPTION OF THE DRAWINGS

Specific embodiments are depicted and described in the drawings presented herein. It will be appreciated that for simplicity and clarity of illustration, elements illustrated in the figures are not drawn to scale. For example the dimensions of some elements are exaggerated relative to other elements for clarity. The use of the same reference symbols in different drawings indicates similar or identical items.

FIG. 1 illustrates an embodiment of a physical configuration of a network access module, and embedded into the physical configuration is a simplified block diagram;

FIG. 2 depicts a simplified communications network which can utilize the network access module of FIG. 1; and

FIG. 3 illustrates a flow diagram of a method of operation in accordance with the present disclosure.

### DETAILED DESCRIPTION OF THE DRAWINGS

The present disclosure is generally directed to systems and methods associated with the use and operation of a network access module. A low-cost network access module having a dongle-type housing is provided. The dongle-type housing is pluggable into a computer port and, when coupled to a communications network, the dongle-type network access module provides an efficient network connection. The network access module contains a processor for negotiating point-to-point network communications with a remote authentication server wherein the subscriber may access the communications network and avoid the extra steps of loading software drivers, configuring the computer, or purchasing expensive equipment. The network access module can be powered by a USB port on the subscriber's computer or by an external power supply.

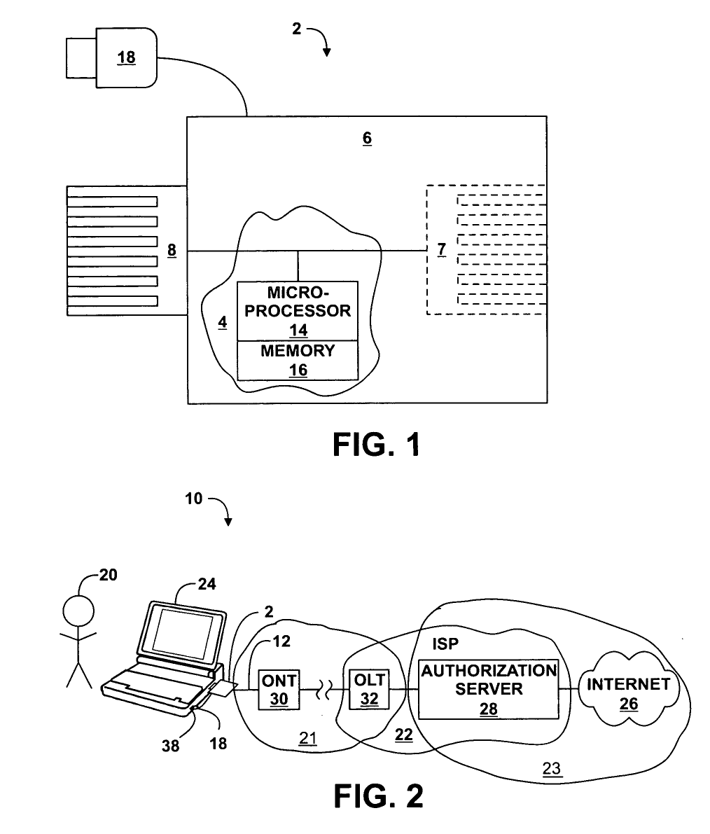

FIG. 1 illustrates an embodiment of a physical configuration of a network access module 2 and a simplified block diagram 4 of internal components of the illustrated network access module 2. The network access module 2 may have the shape and configuration similar to a “dongle.” In reference to the present disclosure, the term “dongle” or “dongle-type” should be accorded a very broad meaning. A dongle is a device that can be inserted into a connector on a computer and may operate in accordance with particular protocols to permit usage of a particular software package on the computer. Dongles are relatively small and often contained within a “connector-sized” housing. For example, a representative dongle is typically less than four (4) inches long by two (2) inches wide by one (1) inch tall. A dongle may have a volume of less than eight (8) cubic inches.

The network access module includes a dongle-type housing 6 that has a first port 7. The first port 7 can be an Ethernet-type receptacle that is recessed in and rigidly attached to the dongle-type housing 6. The first port 7 can be coupled to a communications network via an Ethernet cable such as cable 12 depicted in FIG. 2. The first port 7 can also be attached to the dongle-type housing 6 via a cable (not shown).

Referring to FIG. 1, in a particular application the dongle-type housing 6 has a second port 8 integrated with, or rigidly attached to the dongle-type housing 6 wherein no pendant cable is utilized between the second port 8 and the dongle-type housing 6. Second port 8 is insertable into a network client 24 (typically a personal computer, see FIG. 2). The second port 8 may be an Ethernet-type jack or any other type of suitable connector.

The dongle-type housing 6 can have a third port 18 to provide power to the network access module 2. The third port 18 is illustrated as a USB-type jack on a pigtail that can be inserted into a USB type receptacle. Many personal computers have USB ports and USB ports can supply six volts to the network access module 2. In other embodiments, other power sources such as a “wall charger” or AC-DC power unit—which plugs into the wall—can be utilized to power the network access module 2.

The dongle-type housing includes a processor 14 that can be coupled to the first port 7, the second port 8, and to a memory 16. The memory 16 can be utilized for storing instructions for the processor 14 and subscriber identification data. The memory 16 may also include instructions to be utilized or executed by the processor 14 for connecting a subscriber to the communications network.

The network access module 2 can be utilized to communicate over a wide area network such as a network implemented using digital subscriber lines (DSL), optical fiber transmission lines, optical network terminals, and optical line terminals. When a subscriber's connection request created by a network access module reaches an ISP, the ISP can use an authentication server to negotiate access and provide an Internet connection. The network access module 2 can access a communications network, without loading and configuring software on the subscriber's computer.

Referring to FIG. 2, a block diagram of a communications network 10 is depicted. The system 10 includes a network client 24, the network access module 2, an optical network terminal (ONT) 30, optical line terminal (OLT) 32 an authorization server 28 and the Internet 26. Enclosed areas in FIG. 2 illustrate generally, access network 21, Wide Area Network (WAN) 23 and ISP 22. The ISP 22 can include an optical line terminal 32 and an authentication server 28. The access network 21 can include optical network terminal 30 connected remotely to optical line terminal 32. Optical line terminal 32 is connected to the authentication server 28. The WAN 23 can include an authentication server 28 connected to the Internet 26. Although the drawing and the configuration described above is hardwired, any portion of the network or system may utilize wireless methods. The ISP 22 is remote from the network client 24 and in communication with the network client 24 over DSL a line, or other transmission facility.

When a single subscriber 20 attempts to connect the network client 24 to the Internet 26, an authentication server 28 communicates/negotiates with the network access module 2. The network access module 2 eliminates the need for an expensive router and/or specialized subscriber software. The network access module 2 can readily communicate with the network client 24 and may be under the control of the network client 24. In a particular embodiment, the network client 24 is a personal computer, however, other network devices, such as a telephone or a PalmPilot™ may also be utilized. Authentication procedures may be performed prior to a new subscriber 20 (not to scale) or a repeat subscriber being accepted by the ISP 22 as a valid user. A communications session can be initiated between the network client 24 and the ISP's authentication server 28, without requiring the subscriber 20 to load and configure software onto the network client 24.

The network access module 2 can execute instruction retrieved from memory and communicate on behalf of the network client 24 during the authentication/negotiation process. Accordingly, the processing required, and information needed to establish and/or initiate a connection over a network can be resident in, and performed by the network access module 2 instead of the network client 24. In an illustrative embodiment, the process of establishing an initial connection and subsequent re-connections to the network is provided in a transparent manner for the subscriber 20. This is referred to as a “plug-and-play” feature.

In one embodiment, the second port 8 of the network access module 2 is inserted into the network client 24 and the WAN 23 can be coupled to the network access module 2 using the first port 7 via ONT 30 and OLT 32. The third port 18 of the network access module 2 may be coupled into a USB port 38 of the network client 24 to provide power to the network access module 2.

When a subscriber 20 achieves connectivity, the network client 24 can communicate via the network access module 2 with the authorization server 28 to negotiate a connection to the WAN 23 possibly utilizing a Point-to-Point communications protocol. The network access module 2 can function as a stand-alone negotiator for point-to-point communications with the WAN 23. Network access module 2 may be detached from the network client 24 and connected to other computers or network clients (not shown) to provide seamless connectivity or plug-and-play compatibility. Thus, the network access module 2 can recognize a negotiation request sent by the network client 24. The network access module 2 conducts a communication setup and negotiation between the authentication server 28 and the network client 24 over the WAN 23. Various types of connection protocols may be utilized by the network access module 2 for such setup and negotiation. Below is a list of communication protocols that could be compatible with the network access module 2:

IETF RFC 1332 The PPP Internet Protocol Control Protocol (IPCP),

IETF RFC 1334 PPP Authentication Protocols (PAP),

IETF RFC 1661 The Point-to-Point Protocol (PPP),

IETF RFC 1877 PPP IPCP Extensions for Name Server Addresses,

IETF RFC 1994 PPP,

(CHAP) 4-160 (R) Challenge Handshake Authentication Protocol,

IETF RFC 1570 PPP LCP Extensions,

IETF RFC 2153 PPP Vendor Extensions,

Network access module 2 may be manufactured to support a single protocol or numerous protocols. A description of other compatible protocols and connection topologies is disclosed in USPTO Publication 2004/0001496A1. In a particular embodiment, the network access module 2 uses point-to-point protocol over Ethernet using a DSL connection.

During the initial subscriber setup, the network access module 2 may query network client 24 for subscriber identification data such as user name and password information. The network access module 2 can also store subscriber identification data in the memory 16 so that the subscriber 20 will not have to re-enter the user name and password every time a subsequent connection is to be established. The subscriber identification data can be stored in flash memory within the network access module 2. Storing the subscriber identification data at the network access module 2 allows the subsequent connection process to be transparent to the subscriber 20, creating a plug-and-play Internet connection.

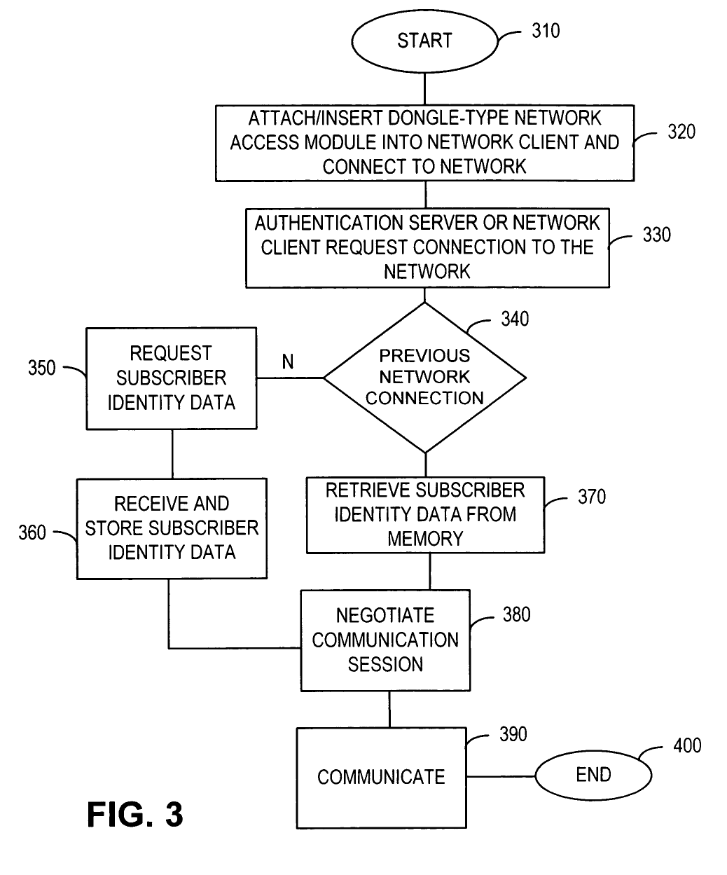

Referring to FIG. 3, a method for connecting a subscriber to a network is provided and commences at block 310. The process proceeds to block 320 where a dongle-type network access module can be attached to a network connection at a first port and to a subscriber's network device at a second port. The dongle type network access module can be inserted into the Ethernet port of a computer and an Ethernet cable can connect the dongle-type network access module to a telecommunications system, such as a DSL line, which is coupled to a communications network.

Dongle type network access module could also be coupled between a hub, a switch or a router, and a WAN to provide connectivity for multiple computers.

Moving to block 330, a connection request between an authentication server and a network client is performed. Next, at block 340, it is determined whether the network access module has had a previous network connection with an authentication server. If the network access module has not been previously connected to an authentication server then the network access module requests subscriber identity data from the network client, as depicted in block 350. Moving to block 360, the subscriber identity data is received and stored. Then, as illustrated by block 380, negotiation for network access begins.

As illustrated at block 340 if the network access module has been previously connected, then the network access module retrieves the stored subscriber identity data at 370, and proceeds directly to negotiate a communications session, as illustrated by block 380. After negotiations, a communications session can occur, as illustrated by block 390. The process ends at block 400.

The above-disclosed subject matter is to be considered illustrative, and not restrictive, and the appended claims are intended to cover all such modifications, enhancements, and other embodiments that fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A network access module comprising:
a dongle-type housing;
a first port of the dongle-type housing coupleable to a communications network;
a second port of the dongle-type housing insertable into a network client; and
a processor coupled to the first port and to the second port, said processor to perform point-to-point network access negotiations such that the network client can access the communications network.

2. The network access module as in claim 1, wherein the network client is a personal computer.

3. The network access module as in claim 1, wherein the processor can execute instructions to connect the network client to a Wide Area Network.

4. The network access module as in claim 1, wherein the dongle-type housing has a volume of less than 8 cubic inches.

5. The network access module of claim 1, further comprising a third port attached to the dongle-type housing to accept a power input.

6. The network access module of claim 5, wherein the third port is insertable into a USB type receptacle.

7. The network access module of claim 1, wherein the second port is a Ethernet compatible.

8. The network access module of claim 1, wherein the processor utilizes subscriber identification data retrieved from a memory within the network access module to access the communications network.

9. A network access module comprising:
a dongle-type housing;
a first port rigidly attached to the dongle-type housing and coupleable to a connection to a communications network;
a second port rigidly attached to the dongle-type housing and coupleable to a network client;
a processor coupled to the first port and to the second port; and
a memory coupled to the processor, the memory including communications network access instructions and subscriber identification data to provide negotiations and access to the communications network.

10. The network access module as in claim 9, further comprising: a third port coupleable to a USB receptacle of the network client.

11. The network access module as in claim 9, wherein the communications network access instructions and subscriber identification data conform to a point-to-point network connection.

12. The network access module as in claim 9, wherein the memory further includes flash memory.

13. The network access module as in claim 12, wherein the flash memory can store user identification and password information.

14. A communication system comprising:
a network client; and
a dongle-type network access module insertable into the network client to negotiate a communication session between the network client and a communications network.

15. The communication system as in claim 14, wherein the network access module further includes a power connector.

16. The communication system as in claim 15, wherein the power connector is insertable into a USB type receptacle.

17. The communication system as in claim 15, further comprising:
an optical network coupleable to the dongle-type network access module, and
an authentication server coupled to the optical network wherein the authentication server negotiates with the dongle-type network access module to provide access to the communication network.

18. A method of providing networked communication services to a single subscriber comprising:
receiving subscriber identity data from a dongle-type network access module coupled to a network client;
authenticating the single subscriber at an authentication server after receiving the subscriber identity data; and
providing a communication session between a wide area data network and the network client.

19. The method of providing networked communication services as in claim 18, further comprising the steps of:
storing the subscriber identity data in a memory within the dongle-type network access module; and
re-authenticating the single subscriber using the stored data retrieved from the memory when a subsequent access to the wide area data network is requested.

20. A method for single client connectivity to a communications network comprising:
negotiating a communication session between a communications network and a dongle-type network access module attached to a network client associated with a subscriber; and
communicating data between the communications network and the network client.

21. The method for single client connectivity as in claim 20, further comprising;
receiving data associated with the single client identity retrieved from a memory within the dongle-type network access module; and
authorizing a second communications session on behalf of the single client after receiving the stored data retrieved from the user memory.
